(19) United States
(12) Patent Application Publication
(10) Pub. No.: US 2016/0290847 A1
(43) Pub. Date: Oct. 6, 2016

(54) PULSE-WAVE ULTRASOUND PRODUCTION WELL LOGGING METHOD AND TOOL

(71) Applicant: BERGEN TECHNOLOGY CENTER AS, Laksevag (NO)

(72) Inventors: Sondre GRONSBERG, Bergen (NO); Dag-Hakon FRANTZEN, Loddefjord (NO)

(73) Assignee: BERGEN TECHNOLOGY CENTER AS, Laksevag (NO)

(21) Appl. No.: 15/103,163

(22) PCT Filed: Dec. 9, 2013
(86) PCT No.: PCT/NO2013/000056

§ 371 Date: Jun. 9, 2016

(51) Int. Cl. G01F 1/66; G01N 29/26; E21B 47/10; G01N 29/06; E21B 47/16

(52) U.S. Cl. CPC G01F 1/663; G01N 29/0654; E21B 47/16; E21B 47/101; G01N 29/262; G01N 2291/106; G01N 2291/2636

(57) ABSTRACT

A pulse-wave ultrasound production well tubing wireline logging method using a logging tool communicating via a wireline to a surface read-out unit, said logging tool provided with a frustoconical ring-shaped linear ultrasound transducer array comprising ultrasound transducer elements, the tool arranged for switching between a PW echo backscatter imaging processing mode and a Doppler measurement processing mode, for transmitting, generating a number of digital signals, and beam-forming said signals to represent ultrasound beams, converting said digital signals to voltage signals, connecting the voltage drive signal channels to oppositely directed consecutive series of said transducer elements, and transmitting wave pulses as said two opposite ultrasound beams (A) and (B) to the fluid in the tubing; and for receiving, receiving returning signals and converting to analogue voltage signals, amplifying the voltage signals, converting them to digital signals and beamforming them, and combining the digital signals to a received digitized ultrasound time signal series for each ultrasound beam (A) and (B), in said PW backscatter mode, forming a an ultrasound image data for beams (A) and (B), in said Doppler mode, producing Doppler measurements for said focused point for each beams (A) and (B) sending images and Doppler measurement to the surface read-out unit.

The present invention is a combined ultrasound imaging and Doppler wireline logging sonde tool. More specifically the present invention is a wireline logging apparatus serving a dual purpose: A first purpose is ultrasound imaging of the production pipe wall in a petroleum production well or the like. A second purpose is conducting Doppler measurements of flow velocities of fluids in the well, particularly for measuring flow velocities in the annulus fluid surrounding the production pipe. The logging sonde may be controlled from the surface to switch between the above operation modes.

### BACKGROUND ART

An overview of ultrasonic sonde setup is described in NASA preferred reliability practices, Practice NO. PT-TE-1422, “Ultrasonic testing of aerospace materials”, pp. 1-3. The document presents

1) the pulse-echo method wherein the ultrasonic transmitter and receiver are combined and placed at one side of the subject to be tested,

2) the through-transmission method wherein the ultrasonic transmitter and the corresponding receiver are placed at opposite sides of the subject material to be tested, and

3) the pitch-catch method, wherein the ultrasonic transmitter and the corresponding receiver are placed at the same surface of the material to be tested, whereby the ultrasonic energy is transmitted at an angle and received at an angle. By these three transmitter-receiver setups, internal flaws may be found.

U.S. Pat. No. 4,947,683 Minear et al., “Pulsed ultrasonic Doppler borehole fluid measuring apparatus”, published Aug. 14, 1990, describes a logging sonde for use in a producing well, including centralizers to center the sonde to make an annular flow around it within the producing channel. The logging sonde comprises an ultrasonic transmitter/receiver which is mounted at the lower portion of the sonde for transmitting downwards and with an angle off the vertical axis of the sonde and the borehole, please see its FIG. 2. The transmitter/receiver mount is rotated about the vertical axis of the sonde in order for the transmitter/receiver to sweep out a conical surface through the upwelling fluid in the borehole. Material inhomogeneities such as gas bubbles form reflective interfaces in the fluid flow which scatter ultrasonic pulses so that a return pulse is formed. The transmitter transmits short ultrasound bursts at a repetition rate, and has several time gates for receiving backscattered reflections from gas bubbles, sediment particles or droplets in the relevant distance range within the production fluid flow. Doppler shift in the return pulses due to the inclusions' vertical velocities are measured, thus the fluid flow velocity is found. The Doppler frequency shift relates to the fluid velocity as

Δf=2f/c(V_{T}+V_{S}),

wherein f is the transmitted frequency, c is the speed of sound in the fluid, V_{T} is the tool velocity (which is usually known on the wire drum topsides) and V_{S} is the velocity of the scattering particles, both with a sign.

EP0442188 published Aug. 21, 1991, withdrawn 1995, “Downhole Doppler flowmeter” is a device for measuring the upward flow velocity in a borehole. It has a similar obliquely-arranged set of transmitter and receiver as for U.S. Pat. No. 4,947,683 above, but with the transmitter and receiver arranged not at the lower end but at the lateral face of the sonde, please see its FIG. 1, thus measuring the annulus flow past the logging sonde. In order to correct for the local borehole diameter's effect on the annulus flow velocity past the sonde which is in the flow itself, and not in an annulus around any pipe, diameter measurements from a caliper logging device on the sonde are included for correcting the Doppler shift measured velocity to obtain the actual upward flow velocity in the borehole.

US-patent U.S. Pat. No. 3,603,145 published Sep. 7, 1971 describes a method of monitoring fluids and flow in a borehole, comprising using a wireline logging sonde with an ultrasound transducer of predetermined frequency and with downstream and upstream acoustic receivers at known distances above and below, for measuring frequency shifts and thereby detecting upstream and downstream acoustic (sound) velocities. The difference between the upstream and downstream acoustic velocities gives a fluid flow velocity of the fluid past the sonde. The upstream and downstream sound velocities are related to fluid density.

As the acoustic velocity depends on density, and in the cited US-patent only the fluid flow velocities and the fluid acoustic velocities are sought, the acoustic signals propagating through the borehole wall and through the rocks must be discriminated. Thus that prior art document describes devices for directing the acoustic energy primarily through the fluid column in the borehole. Further, the document describes attenuators for reducing the signal transmission through the borehole wall. The acoustic measurement signals are passed through the wireline to the surface. At the surface the acoustic measurement signal are read out on a surface read-out unit reading the measurements from a signal transmission such as brushes on the wireline drum. The acoustic measurements received on the surface read-out unit are correlated with readings from a wireline logging depth measuring sheave at the surface, and recorded.

### SUMMARY OF THE INVENTION

Briefly, the invention is a pulse-wave ultrasound production well tubing wireline logging method using a logging tool (0) communicating via a wireline to a surface read-out unit,
said logging tool provided with a frustoconical ring-shaped linear ultrasound transducer array (04) comprising ultrasound transducer elements (041),

comprising
switching between a PW echo backscatter imaging processing mode and a Doppler measurement processing mode, and

for transmitting ultrasound signals,
generating a number (n) of digital signals, and beam-forming said signals to represent ultrasound beams (A,B), converting said digital signals to voltage signals, connecting the voltage drive signal channels to oppositely directed consecutive series of said transducer elements (041), and transmitting wave pulses as said two opposite ultrasound beams (A) and (B) to the fluid in the tubing; and
for receiving ultrasound signals,
receiving returning signals and converting to analogue voltage signals, amplifying the voltage signals, converting them to digital signals and beamforming them, and combining the digital signals to a received digitized ultrasound time signal series for each ultrasound beam (A) and (B).

In said PW backscatter mode, forming a an ultrasound image data for beams (A) and (B), and in said Doppler mode, producing Doppler measurements for said focused point for each beams (A) and (B), and finally sending images and Doppler measurement to the surface read-out unit.

The invention is defined in the set of independent and dependent claims attached.

### FIGURE CAPTIONS AND DETAILS OF EMBODIMENTS OF THE INVENTION

The main purpose of the present invention is to use ultrasound pulse-wave Doppler measurements to detect and measure flow in a petroleum well such as a production well, injection well, or the like, particularly flow in a tubing annulus or casing annulus. Flow in the tubing annulus or casing annulus may be due to leaks and are undesired and the present tool is capable of detecting and measure such flow. Another purpose is ultrasound pulse-wave imaging of the production pipe wall in a petroleum production well, an injection well, or the like. The tool of the invention is for conducting ultrasound pulse-wave Doppler measurements to detect and measure the flow of the fluids in the annulus surrounding the production pipe, and possibly also fluid flow velocities in further annuli such as outside the casing pipe. The Doppler measurements may be corrected for flow within the tubing. The Doppler measurements may also be corrected for clutter due to the tool's own movement, please see below. The production fluid and the annulus fluid may be oil, water or gas or a mixture of those, and may contain particles such as sand, or inhomogeneities. The production pipe annulus and the further annuli may be void and thus only fluid filled, and the casing annulus, if a casing is present, may be gravel packed, or cemented, but still permeable for fluids and subject to undesired leaks. Having the above properties the logging tool may be used for switching between logging for detecting undesired leaks in the well, for ultrasound imaging of the production tubing's inner surface, wall thickness and outer surface to detect pitting, cracks or holes or other irregularities, and for measuring fluid flow velocities in the production pipe annulus or the casing annulus. Doppler measurements within the production pipe may be used for correcting for the Doppler measurements in the production annulus, but other velocity measurements within the production pipe may serve the same purpose.

FIG. 1 is a highly simplified vertical section illustration of part of a completed petroleum well with a cemented casing in a borehole through overlying rocks to an influx zone in a reservoir formation. A first fluid (F1) flows in the production tubing and a second fluid (F2) is present in the annulus space (7). An ultrasound logging tool of the invention is arranged within the production tubing. The ultrasound logging tool of the invention has a frustoconical-shaped linear, ring-shaped ultrasound transducer array (04) of ultrasound transducer elements (041). In an embodiment the transducer array (04) is covered by an ultrasound transparent window around the ring-shaped ultrasound transducer array (04). The transducer array is arranged in a lower portion (013) near the lower end of a main housing (01). The transducer array (04) comprises in an embodiment a number of m=288 transducer elements each with their signal transducing face generally radially outward. The number of transducer elements may not necessarily be 288, but for the present prototype embodiment this provided the possibility of selecting a high number of consecutive transducer elements (041) to be selected among the 288 at a time, for beamforming a transmitted ultrasound beam A (and its opposite beam B) with high azimuthal resolution. Further, the transmitting surface (042) of each of the 288 transducer elements (041) will cover about 1 degree azimuthally. Each transducer element's (041) transducer surface's (042) width is less than ½ of the wavelength, which will have an approximately spherical transmission which is required for beamforming through interference from several transducer elements. The number (m) of elements in said ring-shaped ultrasound transducer (04) may between 64 and 512 depending on the required azimuthal resolution and the wavelength.

In an embodiment of the invention the emitted ultrasound frequency of the pulse wave is in the range 1 to 5 MHz, preferably about 3 MHz. Particularly Doppler measurements may use down to 1 MHz.

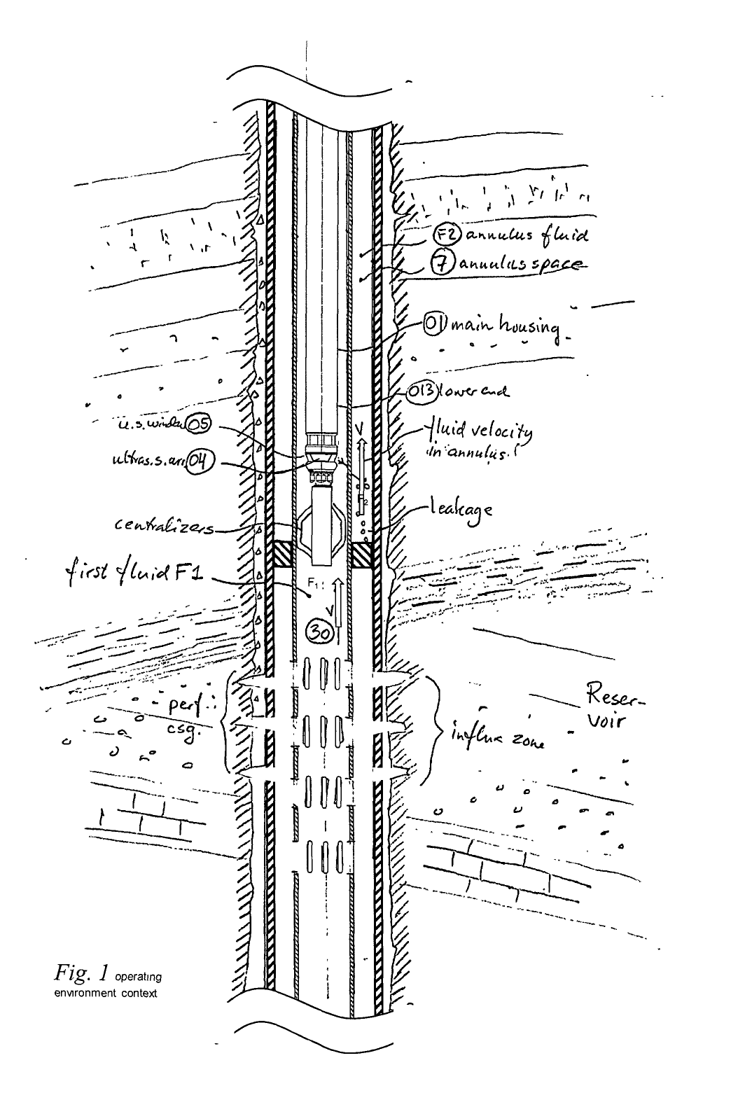

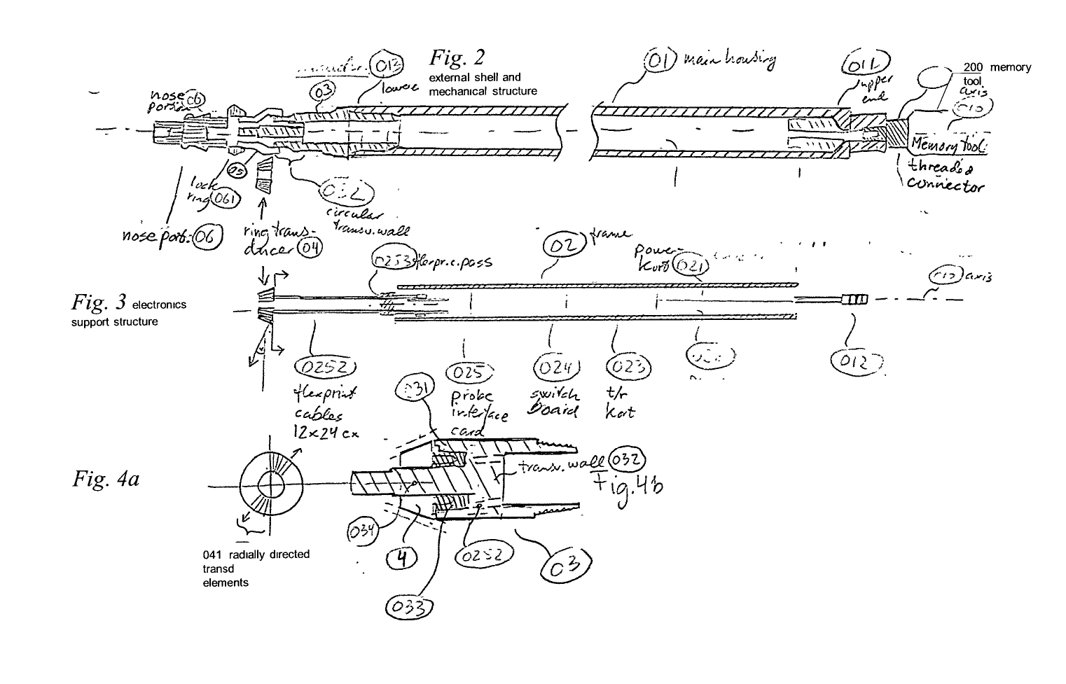

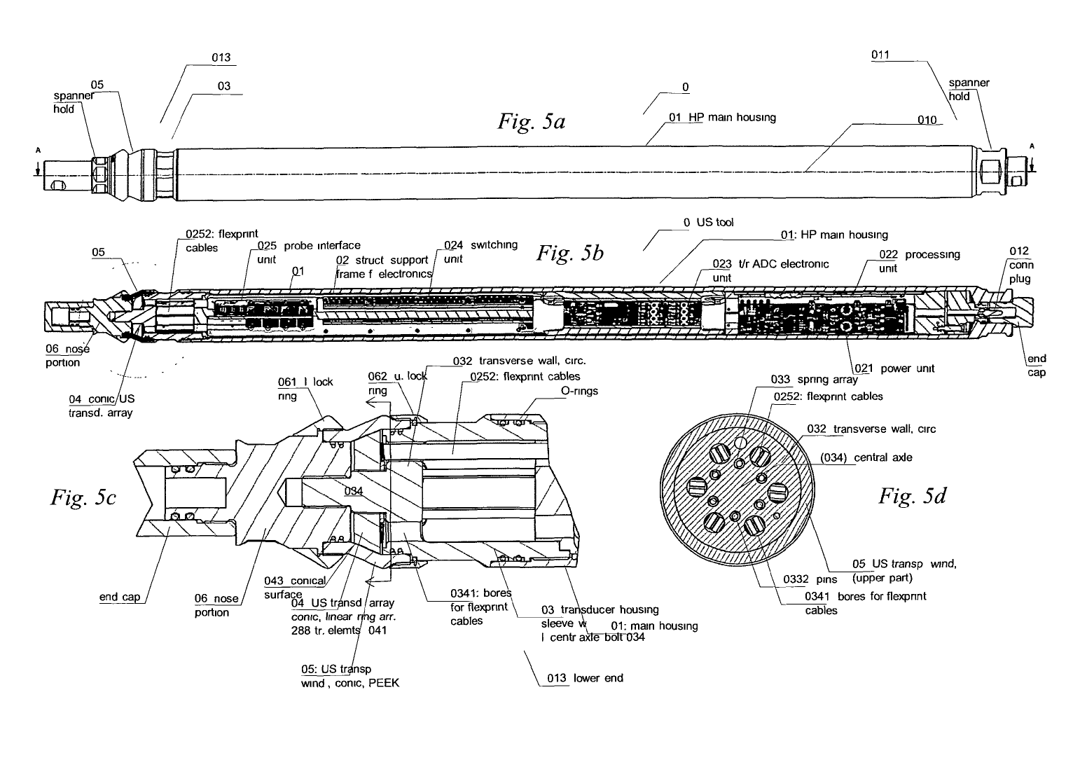

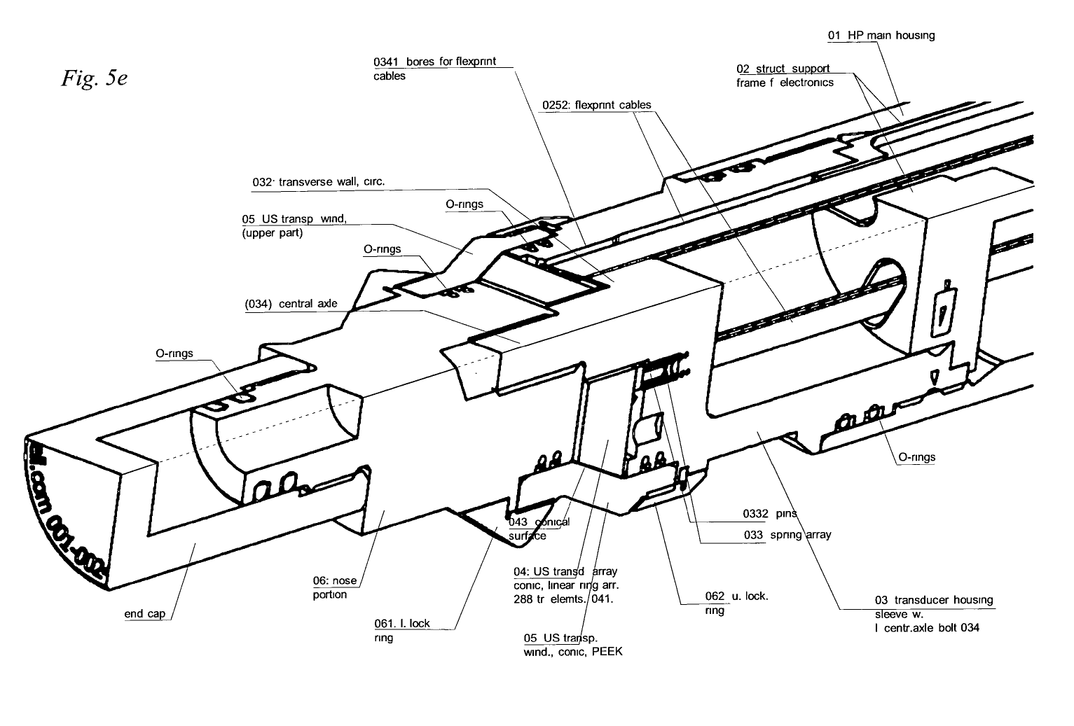

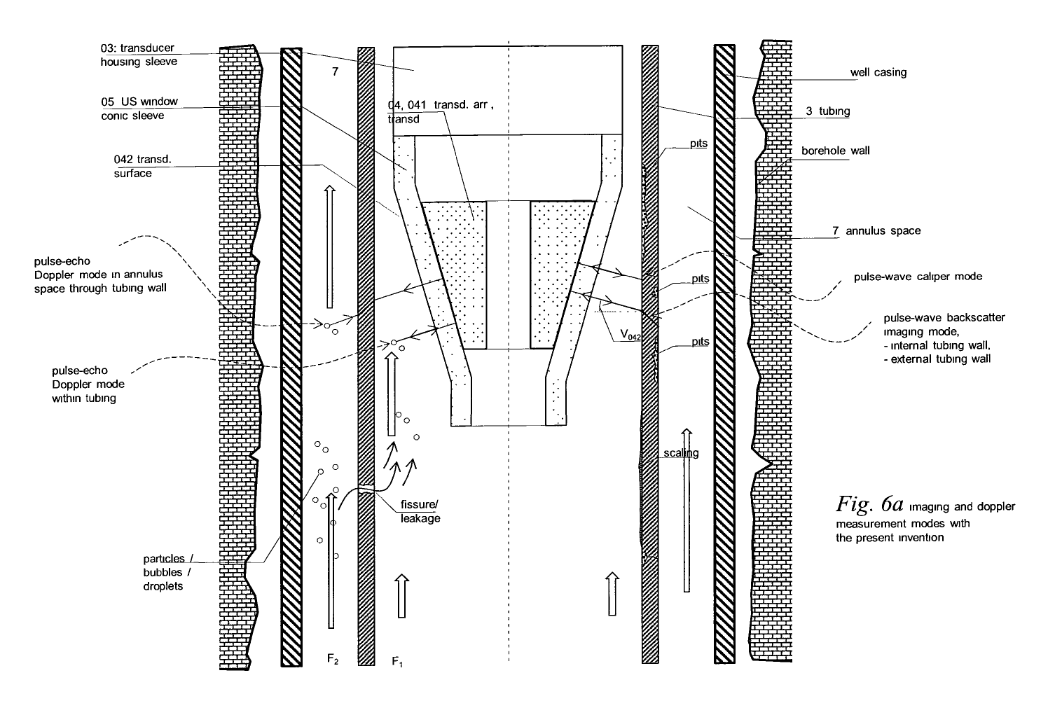

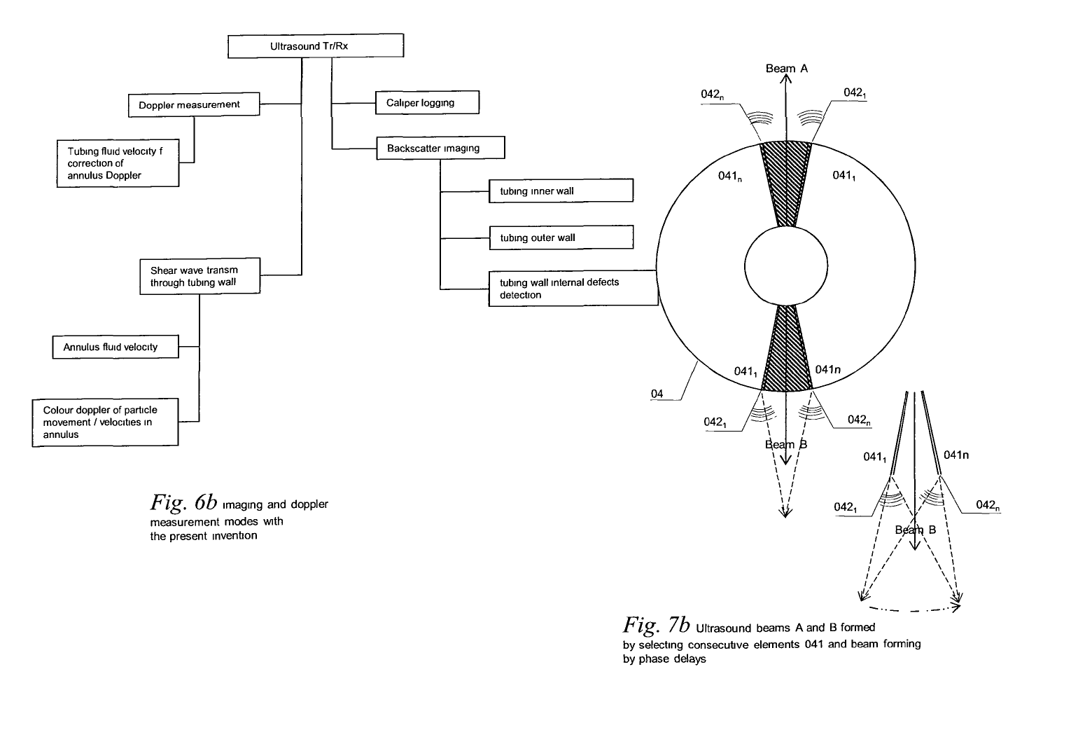

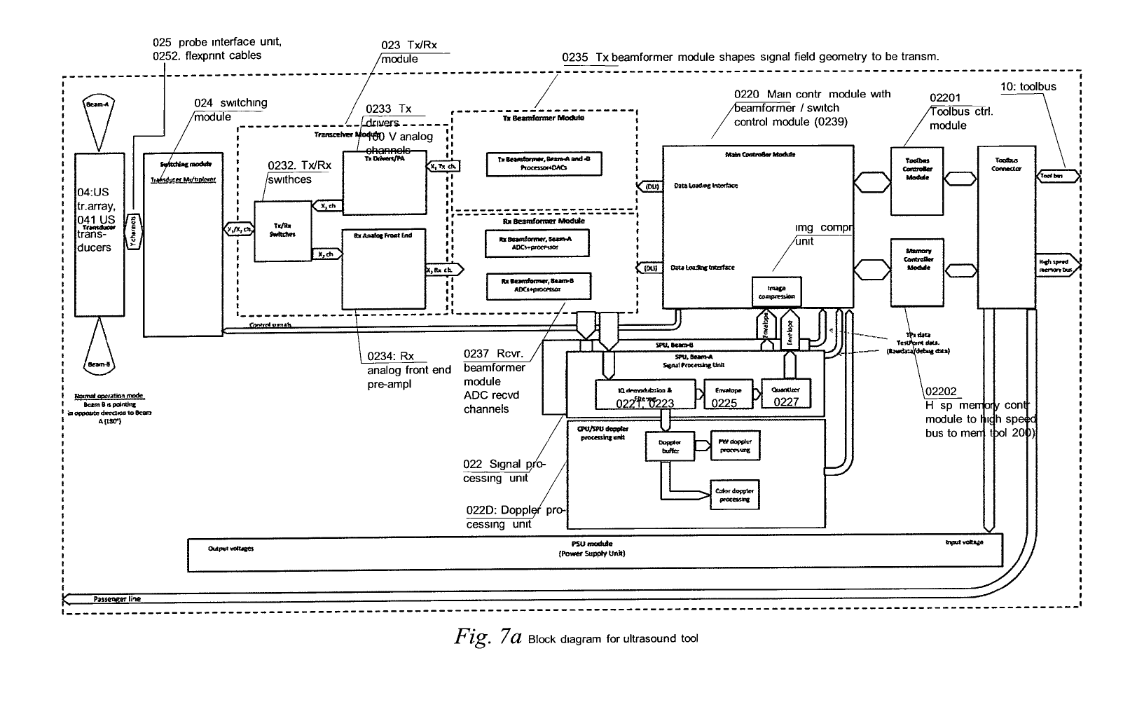

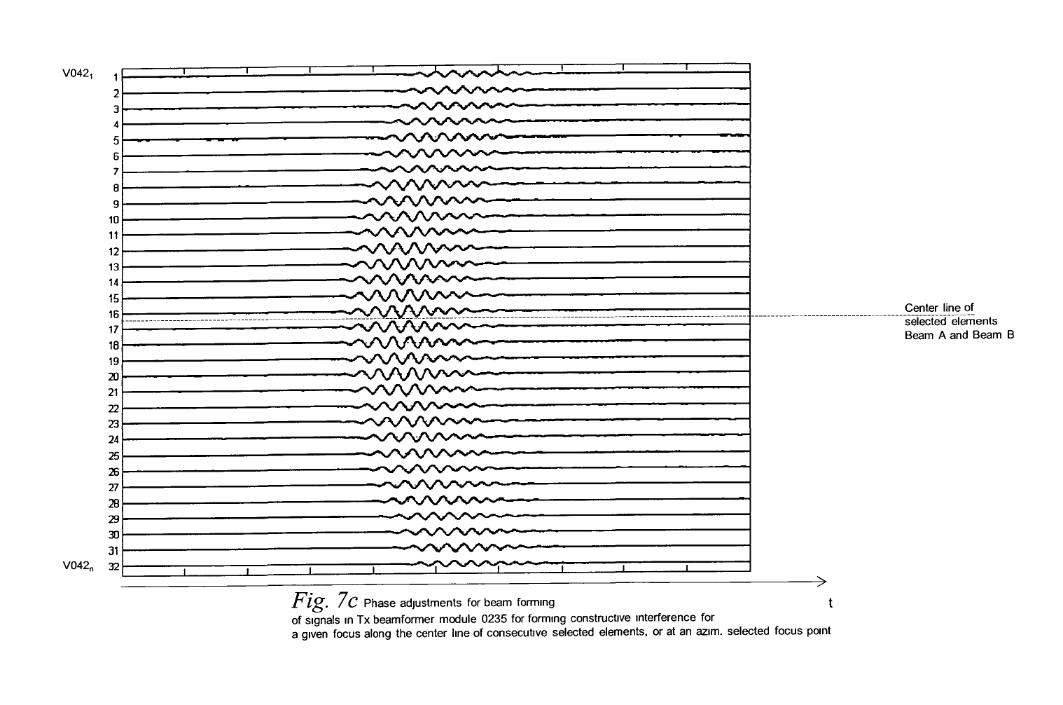

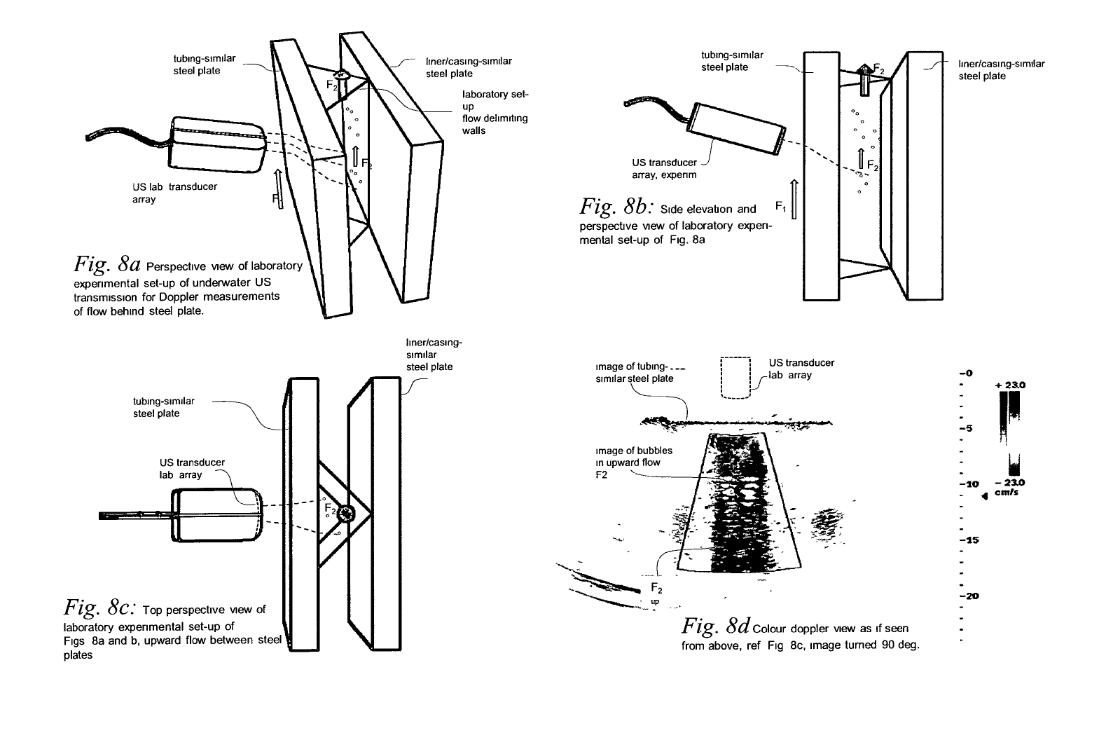

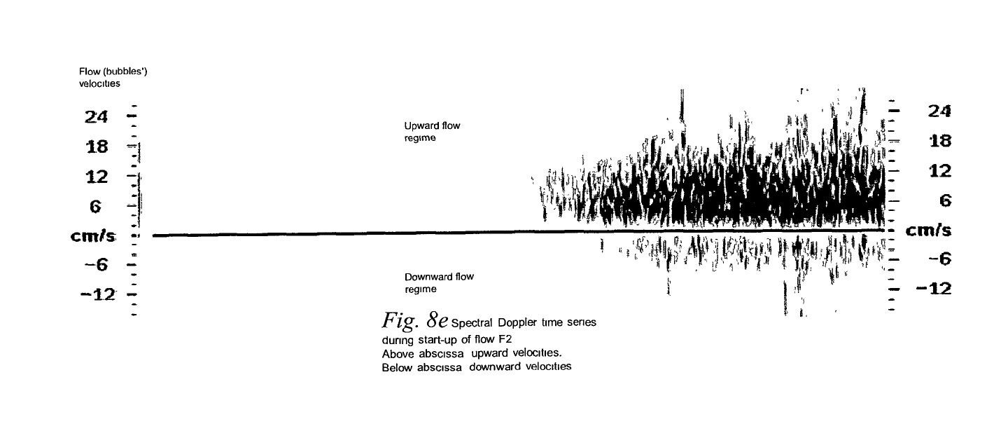

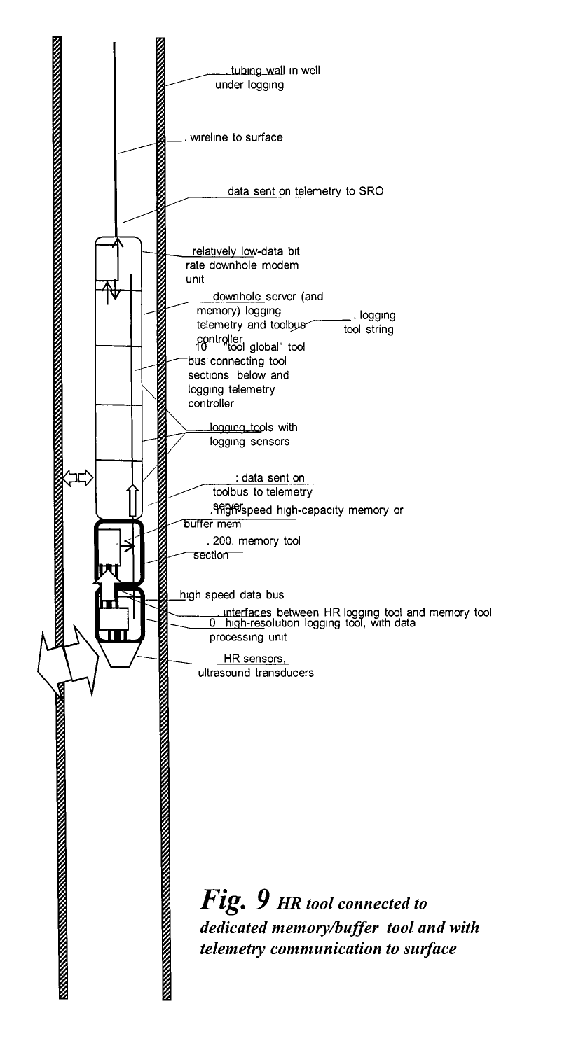

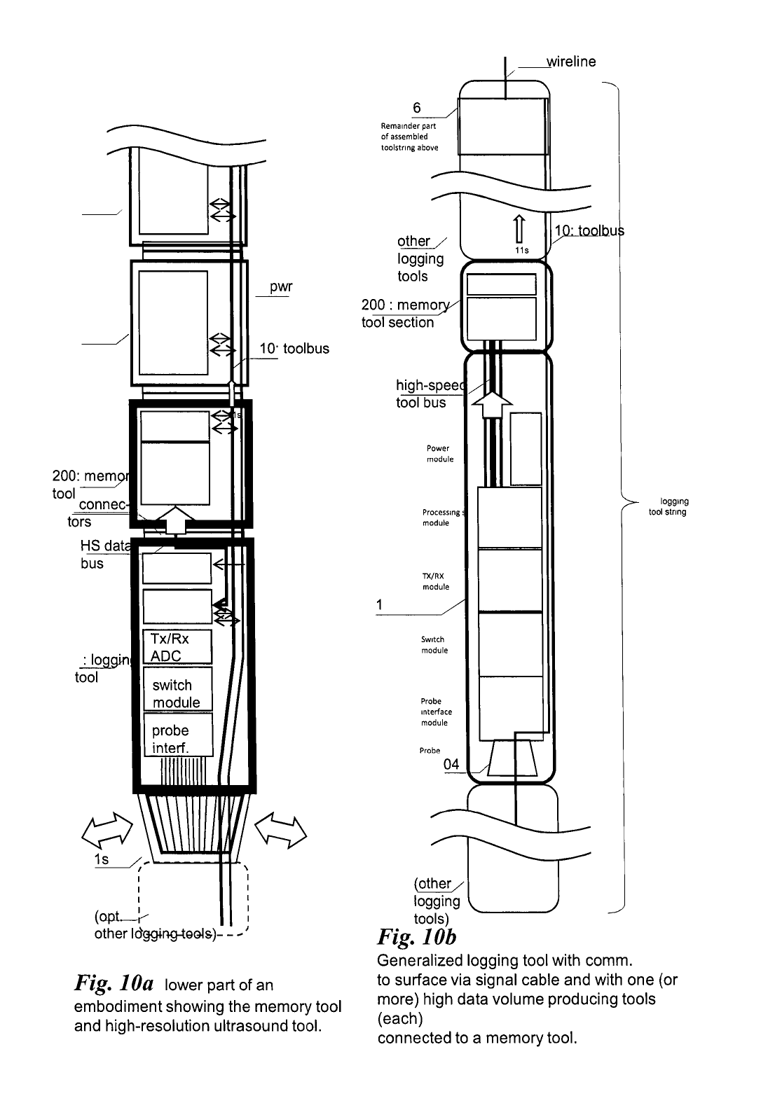

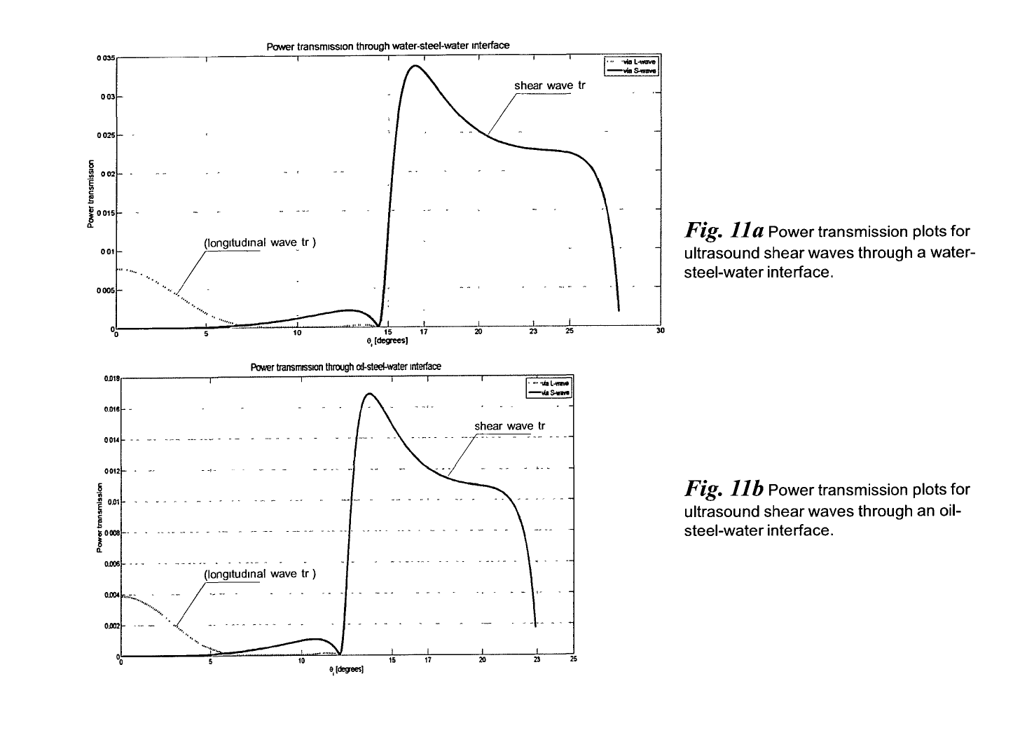

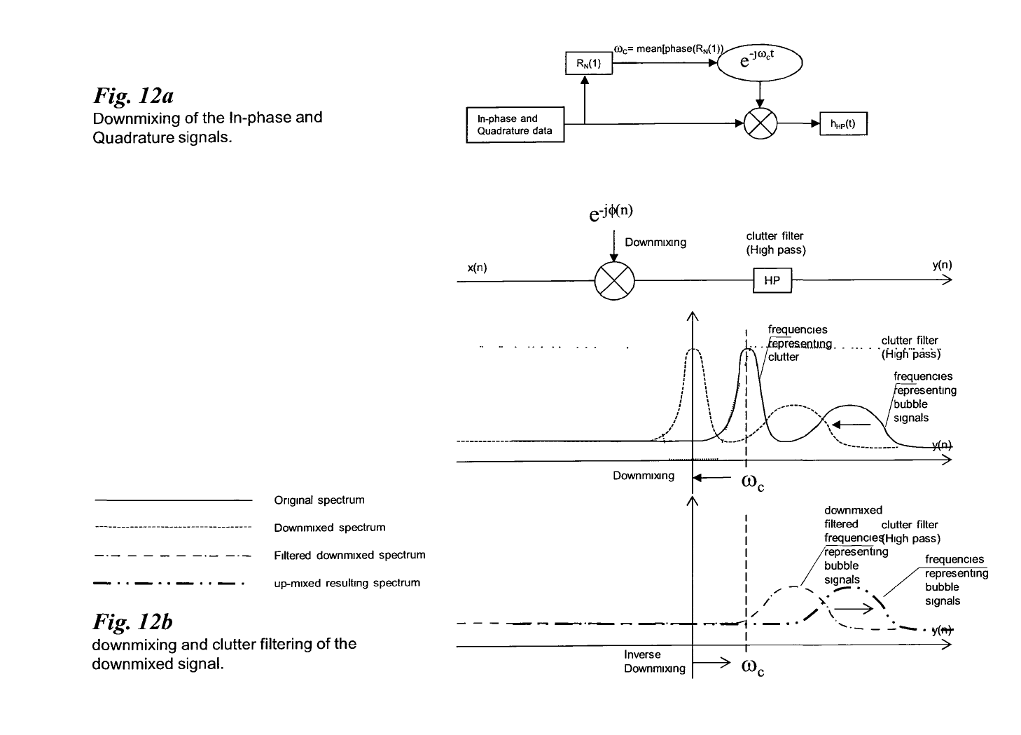

Centralizers may be arranged below the transducer array and also further up along the main housing (01), please see FIG. 1. The ultrasound tool is arranged for operating on a common toolbus with other logging tools in a logging tool string, please see FIG. 9, FIG. 10a and FIG. 10b. The ultrasound tool of the invention produces high-density ultrasound data at a high bit rate, the high bit rate exceeding the global bit rate on an ordinary toolbus usually connecting all tool sections with a telemetry server connected to a signal cable to a surface read-out unit, and certainly the telemetry bit rate at the signal cable itself, which is the main limiting bit rate factor. The ultrasound tool according to the invention is in a preferred embodiment connectable to a dedicated high capacity memory tool section (“02”) connected immediately above the main housing (01). The ultrasound tool of the invention is arranged for being controlled from the surface and send low-resolution images to the surface via the common telemetry line and the ordinary toolbus while logging, and in the preferred embodiment for using the dedicated memory tool as a buffer for the high-resolution data produced. The dedicated memory tool may then be polled from the surface read-out unit for part of or all of the high-resolution data when capacity on the telemetry line is available.

FIG. 2 is a highly simplified illustration of a vertical section through the mechanical structure of the ultrasound logging tool of the invention. In an upper end (013) of the main housing (01) is a connector to the above tools in a toolstring. In a preferred embodiment of the invention the connector particularly has, in addition to the common power line and the toolstring-common toolbus, also connectors for the high speed data bus to the dedicated memory tool (200), please see FIG. 7a. In the lower portion (013) of the main housing (01) is a transducer housing sleeve (03) with a transverse wall (032) with a downward extending central axle (034). The central axle (034) serves two purposes; it forms the support of the ring-shaped ultrasound transducer array (04) and it further supports a subsequent nose portion (06) below the transducer array (04). In an embodiment of the invention an ultrasound transparent funnel-shaped window sleeve (05) surrounds the transducer array (04) and is held in place between the lower outer portion of the transducer housing sleeve (03) and the nose portion (06), and is locked to the transducer housing sleeve (03) by an upper locking ring (062) and to the nose portion (06) by a lower locking ring (061). The locking ring (061) has a diameter slightly larger than the largest diameter of the ultrasound transparent window (05) in order to reduce the amount of mechanical wear on the transparent window. Further, the locking ring (061) is tapered off radially in order not to block ultrasound waves passing radially and about 17 to 28 degrees down from the transverse plane to the sensor. Inside the main housing the electronics of the ultrasound tool is arranged.

FIG. 3 is a generalized view of the electronics arranged in an electronics structure frame (02) within the ultrasound tool mechanical structure. From the bottom end is illustrated the ultrasound transducer array (04) with its presently embodied 288 ultrasound transducer elements connected through 12 flexprint cables (0252) with a total of 288 conductors, and each flexprint cable having 1 common ground conductor, i.e. 300 conductors in all in the present prototype embodiment. The 12 flexprint cables extend in pairs through six passages (0253) through the transverse wall (032) up to a probe interface module (025). The probe interface module (025) connects further to a switch module (024), further connected to a transmitter/receiver module (023), further connected to a processing module (022). A power module (021) serves the modules which require power. When the electronic modules, in an embodiment each module is arranged at each its board, have been assembled in the electronics structure frame (02), the structure frame (02) is sled into the main housing (01) from the lower end (013), the flexprint cables thread through the passages (0341) in the transverse wall (032) connecting the probe interface card (025) to the transducer array (04), and the transducer housing sleeve (03) is screwed into lower end of the main housing (01). The tool is closed and pressure proof when the ultrasound transducer window (05) and the nose portion (06) are mounted on the central axle (034) and locked by the locking rings (061, 062). In an embodiment of the invention the transducer array as such is designed having a fluid-proof, pressure proof conical portion comprising the transducing surfaces (042) and one may dispose of the conical ultrasound transparent window (05).

FIG. 4a is a rough sketch of a cross-axial section of the linear ring-shaped ultrasound transducer (04) with some of its transducer elements (041),

FIG. 4b is a rough illustration of a longitudinal section of the transducer housing sleeve (03) with its flexprint cable passages (0252) through the transverse wall (032) which carries the downward protruding central axle (034) for holding the transducer (04) and the front portion (06).

FIG. 5a-d is a machine drawing of a preferred embodiment of the logging tool according to the invention, i.e. showing the mechanical structure of the tool to some detail.

FIG. 5a is an elevation view of the logging tool according to the invention, with spanner slots in the main housing (01) near the upper end (011), and a removable protective end cap covering the connector plug (012) which preferably shall be connected to the dedicated memory tool (02). In the lower end (013) of the main housing (01) is arranged the transducer housing sleeve (03) with the ultrasound transparent window (05) and the nose portion (06), all locked by the locking rings. The housing sleeve (03) and the nose portion (06) are provided with spanner slots for mounting and disconnection. A protective end cap, removable, is also shown. The protective cap is removed and provided with a centralizer before introduction to the well in order to hold the tool centrally in the production tubing when logging. This may restrict the temporal ranges required and facilitate caliper logging with the ultrasound tool, and also facilitate the ultrasound logging of tubing wall images and tubing wall thickness, and further facilitating the through wall Doppler measurements of particle or fluid speed.

FIG. 5b is a longitudinal section corresponding to the view of FIG. 5a. From the bottom end is illustrated the ultrasound transducer array (04) with its ultrasound transducer elements connected through flexprint cables (0252) extending through passages (0341) through the transverse wall (032) up to a probe interface module (025) in the electronics structural frame (02). The probe interface module (025) connects further to a switch module (024), further connected to a transmitter/receiver module (023) which is digital to analog in the transmitter direction and analog to digital in the receiver direction. The t/r AD/DA converter module (023) is further connected to a processing module (022). A power module (021) serves the modules which require power, i.e. not the probe interface module. Here is shown the electronic modules in their assembled state in the electronics structure frame (02) sled in place into the main housing (01) from the lower end (013), and locked in place by the transducer housing sleeve (03) screwed into lower end of the main housing (01). The tool is closed and pressure proof with the ultrasound transducer window (05) and the nose portion (06) are mounted on the central axle (034) and locked by the locking rings (061, 062). An advantage of the present assembly is the fact that the ultrasound transparent window (05) is easily replaceable by an onsite operator without disturbing the ultrasound transducer array (04). In the upper end of the main housing (01) is shown the connector plug (021) to the above subsequent tool, preferably the dedicated memory tool (200).

FIG. 5c shows an enlarged cross-section indicated by the ring in FIG. 5b, with details of threads, O-rings, and relative positions of inward and outward threads of the threaded components in the lower end (013). Please notice that the upper locking ring (062) is flush with the outer diameter of the main housing (01) and the largest diameter of the ultrasound transparent window (05) and the lower locking ring (061).

The central bolt (034) is massive in the illustrated embodiment. In an embodiment of the invention the ultrasound logging tool of the invention is arranged not to be the lowest of the logging tools in the toolstring. In such an embodiment the nose portion is replaced by a connector sleeve for through electrical connection passing on from through the central bolt (034).

FIG. 5d is a cross-section view through the line C-C of FIG. 5b, through the circular transverse wall (032) just above the transducer array (04). The section is shown looking in a downward direction from the lower end (013) of the main housing. From centre and out the section shows the central bolt (034) on the circular transverse wall (032), six holes (0331) with a spring array (033) holding pins (0332) extending from the inner, rear portion of the transducer array (04) as seen in FIG. 4b. This spring array yields upwardly in the axial direction when the transducer array (04) is moved by the compressed ultrasound transducer window (05) due to their common conic interface, when subject to increasing pressure in the well, preventing deformation or mechanical damage of the transducer array. Radially outside the spring array holes are the through holes (0341) through the circular transverse wall (032) for the flexprint cables (0252). Radially outside this the circular transverse wall continues into the cylindrical portion of the transducer housing (03), followed by a gasket groove, the upper portion of the ultrasound transducer window (05), and finally the lower portion of the upper locking ring (062).

FIG. 6a is a vertical section through an ultrasound array only according to the invention in a tubing and casing in a well, with a first fluid (F1) flowing upwardly in the tubing and with a second fluid (F2) flowing in the annulus space between the well casing and the tubing (3). The transducer surface (042) is arranged with an angle (V042) with the tool axis which should be parallel with the tubing axis. This assures avoiding a directly reflected ultrasound signal which could otherwise saturate the reception when in receiving mode, but utilizes backscattered p-waves propagating through the fluid (F1).
Caliper logging: At the right side of the axis shown in FIG. 6a is shown pulse-echo caliper logging of the radial distance to the inner tubing wall. Caliper logging may be conducted with diametrically opposite pairs of transducer groups A and B, selectable through the electronic switch board (024) controlled by the beamformer/switch control board (0239), please see FIG. 7a below.
Tubing wall inner face imaging: Pulse-echo imaging of the inner wall is conducted on the same signal mode by selecting the same propagation mode and time windowing to sense for the first backscattered longitudinally propagating ultrasound waves representing the tubing wall. Inner face tubing wall imaging may be used for searching for tubing collars, valves, apertures in the tubing walls, etc. Imaging may also be used searching for undesired depositions of tar or scaling, pitting, cracks, holes and potential sources for leaks.
Tubing wall outer face imaging may be conducted on signals having propagated through the tubing wall as p- or s waves and reflected or backscattered back through the tubing wall and back to the transducer elements (041). To discriminate the desired signal from the outer face from the backscattered and reflected signals from the tubing wall inner face, time window range truncation of the returning ultrasound signal may be conducted in order not to conduct unnecessary data acquisition and processing. This technique is generally used in the present invention in order to select an appropriate investigation depth, and may be controlled by an operator by the surface read-out unit. In the illustration is shown pitting in the outward facing tubing wall.
Doppler Imaging
Tubing internal Doppler measurements may be conducted to measure fluid flow past the ultrasound transducer array (04) in the tubing for correcting annulus flow Doppler measurements.
Tubing internal color Doppler measurements may be conducted to discern particles (sand, rust or other debris) or droplets (of water, oil or gas in one of the opposite phases) entering the tubing through leaks.
Annulus flow may be measured based on ultrasound signals having followed the following path: p-wave emitted in tubing fluid, passing as s-wave through the tubing wall, propagating as p-wave through the annulus fluid, reflected and Doppler frequency changed by the droplet or particle, returning acoustic signal as s-wave through the tubing wall, and arriving at the transducer as a p-wave. for water to steel an optimal incident angle is 17 degrees, and for typical oil-to steel a good incident angle is between 13 and 21 degrees (depending also on oil density), please see FIG. 11b which is a diagram of transmission coefficient for a water-to-steel-to-water interface. For the s waves there is more than 1% transmission between about 15 degrees and 27 degrees, with more than 2% transmission in the range 15.5 to 26.5 degrees. In an embodiment the presently selected angle of the transducer conic angle is in the common good signal transmission range between 15.5 and 21 degrees which will be suitable also for and oil-steel-water interfaces.
Annulus flow may also be measured and imaged using so-called ultrasound colour Doppler imaging, which measures the velocity field behind the tubing wall of individual volume elements of the annulus fluid (F2), please see FIGS. 8a, b, c, d. Further, in FIG. 8e a spectral Doppler series is illustrated, Above the abscissa are approaching or upward flow values up to 24 cm/s, below the abscissa are negative values from −12 cm/s. One may see the onset of flow, here injected air bubbles in an upwelling water flow. The detected values for each instant range from about 2 cm/s to above 15 cm/s, and also some negative speed values.

FIG. 6b is an overview of those different modes of ultrasound pulse-echo petroleum well tubing logging. The actual logging mode is selectable through the main controller board (0220) in the logging tool, please see FIG. 7a, controlled through telemetry from the surface read-out unit and the logging operator.

FIG. 7a is a block diagram of the sensor, electronic, and communication main components of the logging tool of the invention. As all control, communication, and data signals are digital, and all ultrasound signals are acoustic, analog, transducer selection, signal transmission and reception, amplification and transformation and processing must be conducted at an appropriate stage in order to obtain meaningful results.

FIG. 7b is an illustration of ultrasound beams A and B formed by selecting consecutive elements 041 and beam forming by phase delays.

Before the logging operation starts, the ultrasound logging tool according to the invention is assembled into a logging tool string.

With reference to FIG. 7a, the operation of the tool is outlined here.

Mode Selection
The operator at the surface selects at a surface read-out unit (SRO) which operation mode the logging tool of the invention to be used, either imaging (with caliper logging) mode or Doppler mode. The control signals are sent via the toolbus to the toolbus controller card (02201) which sends the command to the main controller board (0220).

General Ultrasound Signal Transmission and Acquisition of the Invention
Both for imaging and Doppler modes, the beamformer/switch control board (0239) selects which pair of transducer elements (041) to form the centre line for opposite beam (A) and beam (B), and which depth to focus on. Generally for the invention, 2ⁿ elements (041) to either sides of the selected centre line are then selected to be the two azimuthal parts of the array of 2×2ⁿ elements (041) forming each beam (A) and (B). One may have in mind the number of 2ⁿ=16 elements (041) as an embodiment, but we do not settle at any specific value in this introduction. 2ⁿ=16 is only an example based on the presently developed prototype of the invention, and may in other embodiments be 4, 8, 16 or 32 depending on the azimuthal transducer density in the ring-shaped ultrasound transducer array (04).

The 2ⁿ elements (041) to either sides of the selected centre line are selected to be the two azimuthal parts of the array of 2×2ⁿ elements (041) forming each beam (A) and (B), please see FIG. 7b. In an embodiment of the invention, when operating with radially directed beams (A) and (B), the central element is shifted one at a time, covering 180 degrees each for beam (A) and (B), thus together covering 360 degrees for a half, 180 degrees turn of the centre line.
The beamformer/switch control board (0239) sends two commands for transmitting:
   Transmitter Selection
   1) a command signal down to the switch board to connect the required 2ⁿ transmitter channels to connect to the 2ⁿ analog output signals, from a transmitter driver (0233) (described below) to the at any time selected set of 2×2ⁿ consecutive ultrasound transducer elements (041) of the ultrasound transducer (04) to form a beam (A) (and also (B)) at a time. A practical limit is the number of 2ⁿ channels at the transducer/receiver switch board (024), presently 16 channels connected to a series of 32 consecutive transducer elements (041) of each beam (A) and (B).
   Beamforming
   2) a command signal to a transmit “Tx” beamformer module (0235) which shapes the digital signals which further down in the process shall be converted to an ultrasound acoustic field to be transmitted from the fan of 2×2ⁿ ultrasound transducer elements, while focusing at a desired depth (time), please see FIG. 7c below.
The Tx beamformer module (0235) calculates 2×2ⁿ⁻¹ digital transmit signals, with delays depending on the distance from the central line, please see FIG. 7c, in order to transmit a wavefront in a common radial azimuthal direction. In order to focus at a point at the commanded distance the phases of the signals are changed. Due to internal symmetry in each beam (A) and also in beam (B), it is only required to form one signal curve for each pair of symmetrically arranged transducer elements (041) about the centre line, and also use the same signals for corresponding elements in beam (A) and beam (B).
The Tx beamformer module's (0235) 2ⁿ channels send their individually formed calculated, phase adjusted, digital beam-forming bundle of signals further to 2ⁿ digital-to-analog converters with amplifiers in the Tx drivers/PA (0233). In an embodiment of the invention the amplifiers generate an analog transmit signal for each transducer element (041) in the range of 100 Volts.

Digital Signals to Analog Signals
The 2ⁿ analog signals are sent from the corresponding 2ⁿ Tx driver/power amplifier channels (0233) through transmit/receive control switches (0232) to the switch board (024) which connects the analog signals to the selected consecutive series of 2×2ⁿ transducer elements (041) with two elements, #2ⁿ and #2ⁿ+1 in the present embodiment, about the selected centreline. The actual pair of two transducer elements about the selected centre line for each azimuth is selected by command from the beamformer/switch control board (0239) as described above. Due to beam transmission symmetry, each one of the 2ⁿ channel's amplified analog signal is sent further to a pair of two ultrasound transducer elements (041) having the same relative positions about the centreline selected for each beam A and B. Due to azimuthal transmission symmetry, the same signal is also directed to transducer element pairs in both beam A and beam B, i.e. four transducer elements (041) receive the same analog signal to be transmitted. It is assumed that acoustic signals in beams (A) and (B) will not interfere.

Analog Signals to Transducer Elements (041)
The analog Tx signals are transmitted from the switch board (024) via the probe interface card (025) through the flexprint cables (0252), each conductor connected to a single transducer element (041), which converts the analog voltage signal to an ultrasound signal. The returning signals, whether they have been reflected, backscattered, then reappear as a wavefront at the same groups of transducer elements (041), and in “reflected beams” corresponding to beams (A) and (B), respectively.

Transmission of Signals
The ultrasound signals from the groups A and B of 2×2ⁿ selected consecutive transducer elements (041) propagate as a focused acoustic front, similar to the signal trains illustrated in FIG. 7c, out through the ultrasound transparent window (05), and forms a p-wave into the surrounding first fluid (F1), and is partially reflected or backscattered from the inner face of the tubing. A proportion of the acoustic energy of the acoustic signal is transmitted through the steel wall, depending on densities and incident angles. As explained above, for a water-steel-water transmission coefficient, please see FIG. 11a, a value of 17 degrees incident angle for the p-wave will propagate well as s-wave energy through both water-steel-water and oil-steel-water interfaces. For incident angles below 14.5 and 12.3 degrees, respectively, very little s-wave energy will be transmitted through the steel wall.

Returning Signals
The ultrasound signals having passed the tubing wall will then propagate as p-s-p-waves and be reflected from inhomogeneities in the annulus fluid and reflected back through the same p-s-p-mechanism and reappear as a small proportion of the initial signal, as a p-wavefront at the same group of 2×2ⁿ consecutive transducer elements (041).

Receipt of Acoustic Signals

By the time of receipt of the acoustic signals at the group of 2×2ⁿ consecutive transducer elements (041), they must be put in a reception “Rx” mode. The two groups A and B are transmitted in unison, but do not represent the same image, so the two groups A and B must be processed separately when they operate in receive “Rx” mode.

The acoustic ultrasound signals received at the two opposite groups (A) and (B), each of 2×2ⁿ consecutive transducer elements (041) must be “receipt beamformed” to be focused at one single point at some stage before they are stacked and further processed. In the present invention this “beam forming” (or wavefront selection) is conducted at the Rx beamformer module (0237), please see FIG. 7a.

Analog to Digital Signals
The analog voltage signals from the 2×2ⁿ consecutive transducer elements (041) in each group A and B are connected through the Tx/Rx switch, now reduced to 2ⁿ analog signal channels from group A, 2ⁿ analog channels from group B, and sent to the analog to digital Analog front end pre-amplifier board (0234) to be amplified, please see FIG. 7a, and then digitized. The amplification is in an embodiment of the invention a variable-gain amplification with different gain for pre-tubing wall backscattering signals and post-tubing wall signals received, please see below.

Rx Beam Forming
The digitized 2×2ⁿ signals from group A and from group B are then forwarded to 20 the Rx beamformer module (0237) and “beamformed”, i.e. separately time-shifted for becoming focused, to become more or less coherent in phase for one single point. The Rx beamforming utilizes different delays along the principle axis selected for transmission and reception, but opposite in time, not dissimilar to seismic trace stacking.
Both for imaging and Doppler modes, the beamformer/switch control module (0239) selects which pair of transducer elements (041) to form the centre line for opposite beam (A) and beam (B), and which depth to focus on. Generally for the invention, 2ⁿ elements (041) to either sides of the selected centre line are then selected to be the two azimuthal parts of the array of 2×2ⁿ elements (041) forming each beam (A) and (B).

In an embodiment of the invention, 2ⁿ=16 elements (041) to either sides of the selected centre line are selected to be the two azimuthal parts of the array of 2×2ⁿ=32 elements (041) forming each beam (A) and (B). The number of 2ⁿ=16 elements (041) to either sides is only an example based on the presently developed prototype of the invention and could as well as 2ⁿ=16 as used here, be selected as 4, 8, or 32. The central line between two central transducer elements (041) is shifted laterally (azimuthally) one element at a time (or several elements at a time, depending on desired azimuthal resolution), covering 180 degrees each for beam (A) and (B), thus together covering 360 degrees for a half turn of the centre line.

Analog to Digital Signals
The analog voltage signals from the 2×2ⁿ consecutive transducer elements (041) in each group A and B are connected through the Tx/Rx switch, now reduced to 2ⁿ signal channels from group A, and 2ⁿ channels from group B, and sent to the analog to digital analog front end pre-amplifier module (0234) to be amplified, please see FIG. 7a, possibly with a variable controlled amplification, and digitized. The number of channels for transmission and reception is given by the selected embodiment of transceiver and switch modules. In the present embodiment one may have 32 Tx and 32 Rx, and one may utilize symmetry in the beam as in the described embodiment herein.

Rx Beam Forming
The digitized 2×2ⁿ signals from group A and from group B are then forwarded to the Rx beamformer module (0237) and “beamformed”, i.e. focused to one be more or less coherent in phase for one single point. The Rx “beamforming” utilizes different delays along the principle used for transmission, but opposite in time, not dissimilar to seismic trace stacking.

For pulse-wave Doppler measurements, both Tx and Rx are repeated for the same beam A and/or B for providing a velocity estimate over a given time range. It is possible to adjust the focus as an inhomogeneity source of the Doppler signal approaches.

The above steps with transmission and reception relates to one sampling of one reflection point in one “depth” of investigation from the transducer. The above steps are repeated for 288/2=144 groups to form 288 points for each depth of investigation, for one elevation in the well, of the transducer elements. Thus one pixel height image scan has been conducted azimuthally, i.e. around the periphery around the transducer ring. This may be a caliper measure scan, an image scan, or a Doppler scan. Such scanned rings may be assembled to a 2-D image of the surroundings for each focus depth, the dimension of the 2-D image determined by the logging depth registrations at the surface log or other depth indicator.

Signal Processing, Storage and Transmission
the received, beam-formed signals are processed in signal processing units (022) which demodulate (0223) the signals, forms envelopes (0225) of the ultrasound signals and quantizes (0227) the demodulated signals into images. The quantized greyscale images are transferred to the main controller board (0220) wherein JPEG or other compression is conducted on the images, which are then in a preferred embodiment transmitted through a memory controller board (02202) to an LVDS bus, which is a high-speed bus, to a memory tool (200) described above.

FIG. 7c is an illustration of the Tx beamformer module (0235) calculated 2×2ⁿ=2×16 digital transmit curves with delays depending on the corresponding transmitting surfaces (042) distance from the central line, in order to transmit a wavefront in a common radial azimuthal direction. In order to focus at a point at the commanded distance the phases of the signals are changed.

FIG. 8a illustrates a vertical section through an experimental setup in a water tank, wherein a multi-transducer scanner head is submerged in the tank at a small distance from a steel plate and directed 17 degrees incidence angle on the plate, and wherein a slow water flow is set up behind the steel plate. There is a second steel plate arranged behind the first one. The water and steel bodies may be compared from left to right with the tubing-internal fluid F1, here water, the tubing wall, the annulus fluid F2, here water, and the casing wall.

FIG. 8b is a vertical view of the same.

FIG. 8c shows, in a view corresponding to FIG. 8b, a colour Doppler image resulting from the setup in FIGS. 8a and 8b, wherein bubbles have been introduced into the water flow. The lighter portions in the middle indicate upward flow up to 20 cm/s or more, while the darker portions to the sides indicate no flow or slightly downward flow. The image clearly indicates detectability of the bubbles in the water, and that their velocity upward or downward may be measured.

FIG. 8d shows, in a similar top perspective compared to FIG. 8c and turned 90 degrees, a colour Doppler image of an upwelling water flow with bubbles introduced as illustrated in FIGS. 8a, b, and c.

FIG. 8e is an illustration of a spectral Doppler time series of the same experimental setup illustrated in FIGS. 8a and 8b. Above the abscissa are approaching or upward flow values up to 24 cm/s, below the abscissa are negative values from −12 cm/s. One may clearly see the onset of flow, here injected air bubbles in an upwelling water flow. The detected values for each instant range from about 2 cm/s to above 15 cm/s, and also some negative speed values. There is a wide variation of velocities for each instant of time.

FIG. 9 is a vertical section through a tubing with a high data bit rate producing logging tool of the invention assembled into a logging tool string comprising other logging tools, not necessarily producing data at a high bit rate. The logging tool of the invention is combined with a dedicated memory tool section (200) arranged just above the ultrasound logging tool's (0) upper end, with the high data bit rate LVDS bus to the high-speed/high capacity memory tool's (200) memory section, which is also connected to the ordinary toolbus (10) of the toolstring.

FIGS. 10a and 10b shows in slightly more detail the features of FIG. 9 and roughly indicate the main components of FIG. 7a, such as a ring-shaped ultrasound transducer array here named (1s), a number of conductors to the probe interface module (025), switch module (024), Tx/Rx ADC module (023), Tx/Rx beamformer module (0235, 0237), beamformer/switch control board (0239) (which sends control signals to switch module (024), please see FIG. 7a).

Device Mechanical Structure

The invention is a petroleum production well ultrasound imaging and annulus fluid velocity logging tool (0), for use in a production tubing (3) conducting a first tubing flow (30) of a first fluid (F1) and surrounded by a tubing annulus space (7) with annulus fluids (F2) in a petroleum production well (100). The logging sonde (0) according to the invention comprises
a fluid-proof cylindrical main housing (01) with an axis (010) having a lower end (013) and an upper end (011) and provided with a power and signal connector (012),
the main housing (01) holding the electronics modules described above in a structural frame (02),
the lower end (013) comprising a transducer housing sleeve (03) with a circular transverse wall (032) with an axially directed spring array (033) for spanning the conical ring transducer array (04) on a central axle (034) against the inner, conical surface of an ultrasound transducer window (05) held by a nose portion (06). The spring array (033) will allow movement of the transducer array (04) when the well pressure compresses the conical window (05) while the spring array (033) will maintain the contact with the transducer surfaces (042). This is important for maintaining the desired transmitted ultrasound pulse shape and for maintaining the desired transmitted and received energy.

Locking rings (061, 062) which are inward threaded and arranged from the nose portion (06) and the transducer housing (03) directions, respectively, secure the lower and upper axially directed sleeve portions of the US transparent window (05). The outer diameter of the locking rings (061) and (062) corresponds to the largest diameter of the main housing (01). The cross-section of the lower locking ring (062) is triangular and tapered off in order not to obstruct the outgoing and incoming ultrasound waves. An advantage of the mechanical structure is the easily replaceable nose portion (06) and ultrasound transparent window (05), and ultrasound array (04), respectively, which are accessible in that sequence at the lower portion (013) of the tool.

### Overview of the Invention

To summarize, the apparatus of the present invention may be used for two main purposes:

I) Ultrasound pulse wave Imaging an inner wall of a tubing (or liner) in a petroleum well.

II) PW Doppler measurements of flow velocities for the fluids of the annulus of the well, in the tubing annulus, and possibly in further annuli, such as the liner annulus or caser annulus.

The image scans and PW Doppler measurements are coupled to the wireline depth encoder measurements and may be assembled to corresponding images. An operator may first image a perforated production part of a well for forming an image of the location and geometry of the perforations made. Subsequently, the operator may shift the apparatus to run in PW Doppler mode for measuring the flow velocities in the area of the perforations detected and imaged. The combined combined image and measurements may provide valuable information on the production conditions in the perforated part of the well.

The imaging is conducted inn azimuthal scans with beams A and B of combined transmitter/receiver sequences as described above. Time windowing is selected in order to acquire a selected probing depth.

Doppler Measurements

The PW Doppler measurements of the fluid flow may be conducted in a selected part of the well, i.e. in the production pipe itself, or in an annulus, and depends on the time window selected by the operator. The transducer angle (V042) allows utilizing the transmission coefficient in the selected angle range which provides good s-wave transmission, which again allows detecting Doppler shifts due to particle or bubble velocities in the annulus, i.e. behind the tubing wall.

The beam forming for conducting Doppler measurements is generally the same as the beam forming for backscatter imaging. For the Doppler measurements, the focus may be changed continuously with increasing two-way travel time during reception, so as for focusing on reflections with progressively increasing distance and two-way propagation time with increasing arrival time at the transducer, reflections which represent bubbles in increasing distance from the transducer. A PW Doppler acquisition may require a number of consecutive pulse emissions in the same direction in order to detect movement, e.g. a number of 16 pulse emissions. A PW Doppler measurement may be commanded by the main controller module to conduct so-called beam interleaving, i.e. sweep the centre line of beam A (and B) azimuthally in order to allow bubbles or particles in one azimuthal direction to move a significant distance during the number of 16 transmission and reception cycles, in order to measure their velocities, and that bubbles over the entire scanned azimuthal area are mapped in the desired depth range. The main controller module (0239) may also command beam interleaving while switching back and forth between PW backscatter imaging mode and PW Doppler mode in order to build a backscatter image of the interior of the tubing which is overlaid by annulus fluid velocity estimates.

The transducer angle used in the present invention is not only for allowing signal transmission through the tubing wall to conduct measurements in the tubing annulus, but also for avoiding direct reflection from the pipe wall, as directly reflected signals contains far more energy than backscattering. Direct reflections would saturate the receiving transducer amplifiers if set to detect post-tubing signals. In an embodiment of the invention, to avoid saturation, an auto-gain algorithm in the Rx analog front end pre-amplifiers (0234) may apply a pre- and post-tubing wall gain function wherein the distinction between pre- and post-tubing two-way travel time is based on automatic tubing wall detection algorithms. The two-way travel time may be deduced during imaging mode while conducting backscatter imaging of the tubing wall, or using pulse measurements during PW Doppler measurements.

A PW Doppler processing is conducted in the Doppler processing unit 022D, please see FIG. 7a. The PW Doppler processing requires significantly more data to do an annulus velocity estimate than pulse-echo imaging of the tubing wall. Therefore it will only be possible to do Doppler processing in a limited number for beam directions at the time because of time of flight limitations. This is because each pulse has to travel all the way from transducer surface to the sample volume at the desired distance and back before a new beam can be sent. If it takes too long time between each time a beam is sent in a specific direction (e.g. while performing beam interleaving) aliasing will occur.

The measured fluid velocities should be corrected for the vertical speed of the tool itself. Irregular movements of the tool may produce reflections which may be attenuated using a clutter filter, please see below. The clutter filter is a high pass filter such as illustrated in FIG. 12b. A number of different clutter filters with different cut-off frequencies may be implemented in the Doppler processing unit (022D) and be selectable from a filter bank depending on the detected instrument velocity relative to the tubing wall amongst other parameters.

### Color Flow

Color flow imaging is made using multi range PW Doppler; multiple sample volumes per region subject to measurements, per “region of interest” (ROI) in the annulus, for each beam. The mean frequencies may be color coded for direction, velocity, bandwidth and signal power. Power and mean frequency are estimated through autocorrelation of the In-phase and Quadrature signal:

P_{N}=R_{N}(0)=1/NΣₖ₌₁^{N}|z(k)|²

wherein k is Doppler sample and N is the number of samples in the estimate, e.g. >=16 for colour Doppler=packet size. For multi range Doppler z(k, I) is used wherein k is the pulse and I is the sample in the pulse.

The velocity estimates can be made from a mean frequency estimator:

ω_{IN}=phase[R_{N}(1)]=arctan[(Im[R_{N}(1)]/Re[R_{N}(1)]]R_{N}=1/NΣₖ₌₁^{N}z(k+1)z(k)*

wherein R_{N} is the autocorrelation function is made with shift on, R_{N} (1), of the complex modulated pulse number N, e.g. a vector with all samples from the region of interest/the sample volume, and ω_{IN} is a mean frequency in radians, where the mean frequency is The number of samples used in the correlation (N) equals the number of samples to be averaged before estimation of mean angular frequency.

The signal power estimate can be made from a mean signal power estimator as above.

For color flow the packet size, the number of pulses to make one velocity vector needs to be kept low in order to achieve an acceptable temporal resolution. For PW Doppler this is not as critical as only one beam direction is used and more samples can be used for filtering. For PW Doppler, a Doppler frequency spectrum is estimated and not only the mean frequency as is the case for Color flow.

### Adaptive Clutter Filtering

While moving a logging tool at a constant speed in the well, or if the logging tool is subject to some residual movement due to mechanical waves in the suspending wire, the backscatter form the pipe wall will have a strong, low frequency contribution to the Doppler spectrum due to the movement. Because the pipe wall backscatter signal is relatively strong compared to the fluid flow it will mask the flow signals. In the Doppler processing module (022D), may in an embodiment be implemented with a monitoring algorithm that continuously (which is particularly important if the tool's movement is uneven relative to the tubing wall) with adjustable averaging window and updating rate of mean frequency estimates conducts the following clutter filtering: Down-mixing the Doppler signal with the mean frequency ω_{IN} which can be estimated from the equation above, please see FIG. 12a, the center frequency of the tubing wall backscatter will thereby be brought close to 0 Hz, please see “downmixed spectrum” in FIG. 12b. The Doppler signal from the tubing wall is thereby maximum attenuated by a high-pass clutter filter, please see “filtered downmixed spectrum”. After filtering the Doppler signal can be mixed back to its original frequency, as shown in FIG. 12b, please see “up-mixed resulting spectrum”. The up-mixed signal is far less dominated by the low-frequency movement-induced clutter. Using this procedure will allow obtaining a Doppler signal of the weak reflections having passed the tubing wall, representing bubbles, particles or inhomogeneities moving in the tubing annulus.

### Advantages of the Invention

A significant advantage of the apparatus of the invention is that one may obtain focused Doppler measurements through the tubing wall of fluid movements. The Doppler annulus measurements may be clutter filtered for correcting for tool movements. One may switch between backscatter imaging mode and Doppler mode, which are both conducted and controlled by software in the tool itself, using control software from the surface. The apparatus is materially the same for the two modes. This implies that one may run several passes in imaging and Doppler mode without having to pull the tool from the well between the two modes. It will also allow combining the two modes in a common user interface at the surface. The tool of the invention may be used for Doppler measurement of flow of fluids through the tubing wall, and the selection of the conical angle to allow s-waves through the tubing wall will in addition reduce direct reflections from the inner face of the tubing, which would otherwise drown the Doppler signal. The Doppler processing and filtering contributes to enhance the weak annulus Doppler signals to allow annulus velocity measurements.

1-49. (canceled)

50. A pulse-wave ultrasound production well tubing wireline logging method comprising arranging a logging tool in said tubing, said logging tool communicating over a toolbus and a downhole telemetry modem via a wireline to a surface read-out unit, said logging tool provided with a frustoconical ring-shaped linear ultrasound transducer array comprising a number of narrow, radially directed ultrasound transducer elements with transducing surfaces forming a conical lateral surface,
wherein
controlling said logging tool to selectively operate in an PW backscatter imaging processing mode and a Doppler measurement processing mode, for a series of pulsed ultrasound transmission and reception against a focused point using said frustoconical ring-shaped linear ultrasound transducer array, comprising
transmitting focused ultrasound wave pulses as two opposite ultrasound beams (A) and (B) in a direction orthogonally from said conical surface, to a surrounding well fluid in said tubing, and
receiving, analogue to digital converting and beamforming returning ultrasound signals representing said opposite beams (A) and (B), and forming a signal envelope of said demodulated digitized signal time series for each beams (A) and (B);
in said PW backscatter mode,
quantizing said enveloped ultrasound data to form an ultrasound image data for a focused point for each beams (A) and (B),
in said Doppler mode,
using a series of said demodulated digitized time signal series producing Doppler measurement data for said focused point for each beams (A) and (B),
wherein, during the Doppler measurement processing mode comprises calculating a mean, relatively low velocity of said Doppler data representing a relatively low tool velocity, and using said mean, relatively low velocity for conducting clutter filtering for removing Doppler data representing said relatively low tool velocity, processing said filtered Doppler data for obtaining Doppler data arising due to fluid flow in an annulus space outside said tubing, wherein in said process of clutter filtering, down-sampling said Doppler data with said mean, relatively low velocity, so as for bringing a frequency spectrum of said down-sampled data representing clutter, to near zero frequency, and high-pass filtering said Doppler data to remove the contribution of Doppler data representing relatively low velocity,
transmitting all or part of said formed ultrasound images and Doppler data on said toolbus, via said wireline to said surface read-out unit.

51. The method of claim 50, for transmitting ultrasound waves, generating a number of digital signals, beam-forming said number of digital signals to represent focused ultrasound beams,
converting said digital signals to said number of voltage drive signals ,
connecting said number of voltage drive signal channels to two oppositely directed consecutive series each of twice said number of said transducer elements,
transmitting focused ultrasound wave pulses as said two opposite ultrasound beams (A) and (B) in a direction orthogonally from said conical surface, to said surrounding well fluid in said tubing,
receiving returning ultrasound signals and converting to analogue voltage signals on said two selected opposite consecutive series of transducer elements, representing said opposite beams (A) and (B),
amplifying said received analogue voltage signals,
converting said received analogue voltage signals to received digital signals and beamforming said received digital signals, and combining said received digital signals to a received digitized ultrasound time signal series for each ultrasound beam (A) and (B),
demodulating said received digitized time signal series for each beams (A) and (B),
forming a signal envelope of said demodulated digitized time signal series for each beams (A) and (B),
said frustoconical ring-shaped linear ultrasound transducer array comprising a number of narrow, radially directed ultrasound transducer elements with their transducing surfaces forming part of a conical lateral surface of said ultrasound array having a conical angle of between 12 and 28 degrees transmitting said ultrasound signals.

52. The method of claim 50, transmitting all or part of said ultrasound formed images or Doppler data via a dedicated high speed memory bus for temporary storing to a dedicated downhole memory tool connected to said logging tool, said memory tool also connected to said ordinary toolbus.

53. The method of claim 50, said Doppler measurements comprising calculating fluid velocity, fluid flow direction, signal power, or flow velocity spectral information.

54. The method of claim 51, said number of signal generating channels being n=2, 4, 8, 16, 32 or 64 channels.

55. The method of claim 51, conducting time-controlled gain of said number of signals in said channels in said receiver analogue front end amplifier for two-way travel times representing before and after backscattering from an inner wall of said tubing.

56. The method of claim 50, conducting Doppler processing for time ranges representing two-way travel times for transmissions from said transducer surface, through said fluid in said tubing at said desired angle, as shear waves through the tubing wall, and through annulus fluid to inhomogeneities in said annulus fluid, thereby obtaining Doppler measurement data for said annulus fluid.

57. The method of claim 50, shifting said beams (A) and (B) laterally for building up line image scans azimuthally of said region of interest,
conducting beam interleaving of one or both of beams (A) or (B) for allowing building up a backscatter image and a Doppler image in the same run,
conducting beam interleaving of one or both of beams (A) or (B) for allowing sufficient movement of an inhomogeneity in said fluid in said tubing or in said tubing annulus to occur, between consecutive ultrasound pulse wave returning from the assumed same inhomogeneity, in the Doppler mode, transmitting calculated Doppler measurement data to said main control module.

58. The method of claim 51, wherein a number (m)=2(n) of elements in said ring-shaped ultrasound transducer is between 64 and 512, more specifically, in an embodiment, m=288.

59. The method of claim 50, conducting pulse-wave backscatter imaging processing for time ranges representing two-way travel times for transmissions from said transducer surface, through said fluid in said tubing at said desired angle, as shear waves through the tubing wall, and to objects or features on the outer face of said tubing wall or through annulus fluid to objects outside said tubing wall, thereby obtaining image point measurements of said objects.

60. The method of claim 50, upon beamforming said received signals, adjusting the focus to increasing radii with increasing two-way travel time and,
to avoid saturation, an auto-gain algorithm in the receiving analogue front end pre-amplifiers applying a pre- and post- tubing wall gain function.
wherein the distinction between pre- and post-tubing two-way travel time is based on a tubing wall detection algorithms, said two-way travel time deduced during imaging mode while conducting backscatter imaging of the tubing wall, or using pulse measurements during PW Doppler measurements.

61. A pulse-wave ultrasound production well tubing wireline logging tool comprising
a cylindrical pressure-proof main housing with a connector in its upper end for communicating over a toolbus and a downhole telemetry modem via a wireline to a surface read-out unit,
wherein
said pressure-proof main housing provided with
an ultrasound transducer housing sleeve portion with a frustoconical ring-shaped linear ultrasound transducer array comprising a number of narrow, radially directed ultrasound transducer elements with their transducing surfaces forming a conical lateral surface, said transducer elements for transmitting ultrasound energy to a surrounding well fluid in said tubing, said conical surface having a conical angle,
a main controller module arranged for selective switching between a PW echo backscatter imaging processing mode in a signal processing module and a for a series of pulsed ultrasound transmission and reception against a focused point using said frustoconical ring-shaped linear ultrasound transducer array
for transmitting focused ultrasound wave pulses as two opposite ultrasound beams (A) and (B) in a direction normal to said conical surface, to a surrounding well fluid in said tubing, and
for receiving, and analogue to digital converting and beamforming returning ultrasound signals representing said opposite beams (A) and (B), and arranged for forming a signal envelope of said demodulated digitized signal time series for each beams (A) and (B);
said signal processing unit arranged for in-phase and quadrature demodulation module for demodulating said time signal series,
an algorithm which, during the Doppler measurement processing mode,
calculates a mean, relatively low velocity of said Doppler data representing a relatively low tool velocity, and uses said mean, relatively low velocity to conduct clutter filtering thus removing Doppler data representing said relatively low tool velocity, processes said filtered Doppler data to obtain Doppler data arising due to fluid flow in an annulus space outside said tubing, wherein, in said process of clutter filtering, down-sampling said Doppler data with said mean, relatively low velocity, brings a frequency spectrum of said down-sampled data representing clutter, to near zero frequency, and high-pass filters said Doppler data to remove the contribution of Doppler data representing relatively low velocity
said main controller module arranged for transmitting compressed image or Doppler data on said toolbus controller module to said toolbus, for communicating to said surface read-out unit.

62. The logging tool of claim 61, comprising
a main controller module with a beamformer/switch control module, arranged for commanding a transmitter beamformer module and a transducer switch module, for commanding and switching between transmitting and receiving ultrasound signals,
arranged for transmitting, commanding a number of signal generating channels in said transmitter beamformer module to generate said number of digital signals, said transmitter beamformer module beam-forming said number of digital signals to represent said pulsed, focused ultrasound beam,
arranged for converting said digital signals to the same number of analogue transmitter driver amplifier channels in a transmitter driver module to form said number of voltage drive signals,
arranged for transmitting said number voltage drive signals via transmitter/receiver switches to said transducer switch module, said transducer switch module connecting said number of voltage drive signal channels to two opposite consecutive series each of twice said number of said transducer elements,
said transducer switch module arranged for switching, connecting said two selected opposite consecutive series each of twice said number of transducer elements internally pairwise symmetrically in each consecutive series, to said number of channels in two separate receiver analogue front end amplifier channels representing said opposite beams (A) and (B) for amplifying said received analogue voltage signals,
arranged for sending said amplified channels' signals to parallel receiver beamformer modules each with said number channels digitally converting and combining said number of signals to one ultrasound time signal series for each ultrasound beam (A) and (B),
a signal processing unit arranged for each beams (A) and (B), for in-phase and quadrature demodulation module for demodulating said time signal series,
said main controller module arranged for switching between said PW echo backscatter imaging processing mode in said signal processing module and a Doppler measurement processing mode in said Doppler processing module,
said processing module comprising a signal envelope forming module arranged for forming a signal envelope of said IQ demodulated data, and a quantizer for sending quantized ultrasound data to an image compression module in said main control module,
a Doppler buffer for temporarily storing demodulated digital signal series in said Doppler processing module and arranged for conducting Doppler processing in said PW Doppler processing module.

63. The logging tool of claim 62, said toolbus controller module connected to said toolbus and to a main controller module having a beamformer/switch control module commanding a transmitter beamformer module and a transducer switch module.

64. The logging tool of claim 63 for said transmitting, said transmitter beamformer module having a number of signal generating channels for generating said number of digital signals and beam-forming said number of digital signals to represent a pulsed, focused ultrasound beam, and sending said digital signals to the same number of analogue transmitter driver amplifier channels in a transmitter driver module to form said number of voltage drive signal channels for being transmitted via transmitter/receiver switches to said transducer switch module, said transducer switch module connecting said number of voltage drive signal channels to two opposite consecutive series each of twice said number of said transducer elements for transmitting said two opposite ultrasound beams (A) and (B).

65. The logging tool of claim 64 for said receiving, said transducer switch module arranged for switching said two selected opposite consecutive series each of twice said number transducer elements internally pairwise symmetrically in each consecutive series, to said number of channels in two separate receiver analogue front end amplifier channels representing said opposite beams (A) and (B), and for sending said amplified channels' signals to parallel receiver beamformer modules each with said number of channels for digital conversion and combining to one ultrasound time signal series for each ultrasound beam (A) and (B).

66. The logging tool of claim 65, said processing module comprising a signal envelope forming module for said IQ demodulated data and a quantizer arranged for sending quantized ultrasound data to an image compression module in said main control module,
said Doppler processing module comprising a Doppler buffer and a PW Doppler processing module, for transmitting Doppler measurement data to said main control module.
said main controller module arranged for transmitting high-resolution image or Doppler data via a high-resolution memory controller module on a high speed memory bus to a dedicated memory tool,
said conical angle being between 12 and 28 degrees,
said front end amplifier channels arranged for time-controlled gain of said channels.

67. The logging tool of claim 62, said transducer array arranged on a lower central axial bolt of a lower transverse wall on said transducer housing sleeve, and comprising a nose portion on said central axial bolt covering the lower face of said frustoconical ring-shaped transducer array,
further comprising a funnel-shaped ultrasound transparent window arranged on said frustoconical lateral surface of said transducer array, said ultrasound window held in place between a lower outer portion of the transducer housing sleeve and said nose portion,
said ultrasound window locked to said transducer housing sleeve by an upper locking ring and to said nose portion by a lower locking ring,
said locking ring tapered off radially about 17 to 28 degrees down from the transverse plane.

68. The wireline ultrasound logging tool of claim 62, said number of signal generating channels being n=2, 4, 8, 16, 32 or 64 channels, preferably n=16 channels,
said number of ultrasound transducer elements being between 64 and 512, preferably 288 elements,
the electronic modules arranged in an electronics structure frame within said housing, said electronic modules comprising, apart from said ultrasound transducer array a number of flexprint cables extending in pairs through passages through the transverse wall up to a probe interface module connected to a switch module, further connected to a transmitter/receiver module, further connected to a processing module.

69. The wireline ultrasound logging tool of claim 66, said dedicated memory tool arranged for storing said high-resolution image data and/or Doppler data and for subsequent uploading of said image and/or Doppler data on said toolbus and said wireline to said surface read-out unit.
